(19) United States
(12) Patent Application Publication
(10) Pub. No.: US 2013/0215861 A1
(43) Pub. Date: Aug. 22, 2013

(54) RANDOM ACCESS METHOD

(71) Applicants: Seung Hyun Nam, Cheonan-si (KR); Hee Wook Kim, Daejeon (KR); Tae Chul Hong, Daejeon (KR); Kun Seok Kang, Daejeon (KR); Bon Jun Ku, Daejeon (KR); Do Seob Ahn, Daejeon (KR)

(72) Inventors: Seung Hyun Nam, Cheonan-si (KR); Hee Wook Kim, Daejeon (KR); Tae Chul Hong, Daejeon (KR); Kun Seok Kang, Daejeon (KR); Bon Jun Ku, Daejeon (KR); Do Seob Ahn, Daejeon (KR)

(73) Assignee: ELECTRONICS AND TELECOMMUNICATIONS RESEARCH INSTITUTE, Daejeon (KR)

(21) Appl. No.: 13/881,436

(22) PCT Filed: Oct. 27, 2011
(86) PCT No.: PCT/KR2011/008049

§ 371 Date: Apr. 25, 2013

(30) Foreign Application Priority Data
Oct. 27, 2010 (KR) 10-2010-0105631

(51) Int. Cl. H04W 74/08

(52) U.S. Cl. CPC H04W 74/0833
USPC 370/329

(57) ABSTRACT

According to the present invention, a random access method between a terminal and a base station comprises: a system information transmission step in which the base station transmits, to the terminal, system information including route values sequentially selected from among a set of routes; a random access preamble transmission step in which the terminal generates a random access preamble on the basis of the system information and transmits the generated random access preamble to the base station; a period setup step in which the base station sets a period available for an arrival of the random access preamble; and a random access preamble detection step in which the base station detects the random access preamble in said available period.

### TECHNICAL FIELD

The present invention relates to a random access method and more particularly, a random access method capable of reducing complexity in detection of a random access preamble during a random access process.

### BACKGROUND ART

A random access process refers to the process through which a user equipment synchronizes itself with a base station for transmitting initial uplink data and requests allocation of resources.

FIG. 1 is a signal flow diagram illustrating a conventional random access process.

With reference to FIG. 1, a user equipment (UE) carries out synchronization with a base station (eNodeB) by receiving a primary synchronization signal (PSS) and a secondary synchronization signal (SSS) from the base station and receives system information through a broadcasting channel (BCH).

The user equipment generates a random access preamble based on the system information and transmits the generated random access preamble to the base station. The base station then detects the random access preamble and informs the user equipment of acquisition of uplink synchronization. Once the user equipment obtains uplink synchronization from the base station, it requests allocation of resources from the base station.

FIG. 2 illustrates a structure of a random access preamble.

With reference to FIG. 2, a random access preamble comprises a cyclic prefix (CP), a preamble sequence, and guard time (GT). A random access preamble can assume various types of formats. The random access preamble shown in FIG. 1 corresponds to format 0, where the length of CP and guard time amounts to 0.1 ms and the length of preamble sequence is 0.8 ms. The format 0 can support cells ranging up to 15 km. Random access preambles in other formats have a different CP, preamble sequence, and GT configured according to their cell size supported.

Current ground network systems based on the LTE (Long Term Evolution) are designed to detect a random access preamble transmitted from a cell having a maximum size of 100 km. Factors related to generation of a random access preamble include a cyclic shift (CS) and a route value. A cyclic shift is a value determined by a cell size while a route value is intended for generating a preamble sequence. A random access preamble originating from a preamble sequence generated from a single route value has a nearly zero cross correlation with a random access preamble generated from other factors.

The user equipment generates 64 candidate random access preambles when generating a random access preamble based on system information and transmits one of the candidate random access preambles to the base station. As a cell size is increased, the size of cyclic shift is accordingly increased to prevent interference between random access preambles and the number of random access preambles generated from a single route value is decreased. Therefore, since multiple route values have to be used to accommodate the increased cell size, the base station incorporates a set of available route values into the system information and transmits the system information containing the set of routes to the user equipment.

When detecting a random access preamble, the base station calculates a cross correlation of the random access preamble received from the user equipment. In case the base station attempts to obtain a cross correlation for each of the route values constituting a set of routes to detect a random access preamble, there may arise a problem for the base station that complexity for detection of a random access preamble is increased.

Communication systems are expected to evolve toward a direction that ground and satellite networks are combined or collaborate with each other. Since a satellite network system employing the LTE provides a significantly broad coverage compared with that of a ground network, random access methods employed for a current ground network are forced only to contribute to increase complexity for detection of a random access preamble.

### DISCLOSURE

### Technical Problem

The present invention has been made in an effort to provide a random access method capable of reducing complexity for detection of a random access preamble at the time of carrying out a random access process in a communication system having a large coverage such as a satellite network system based on the LTE.

### Technical Solution

According to a first aspect of the present invention, a random access method between a user equipment and a base station comprises a system information transmission step in which the base station transmits, to the user equipment, system information including route values sequentially selected from among a set of routes; a random access preamble transmission step in which the user equipment generates a random access preamble on the basis of the system information and transmits the generated random access preamble to the base station; a period setup step in which the base station sets a period available for an arrival of the random access preamble; and a random access preamble detection step in which the base station detects the random access preamble in the available period.

In the system information transmission step, the base station transmits the system information in units of sub-frames for each frame while, in the period setup step, the base station sets up the available period by taking account of at least one of cell radius, propagation delay, re-transmission, latency delay, and resource allocation period.

In the random access preamble detection step, the base station detects the boundary of the random access preamble in the available period and extracts a parameter from the random access preamble.

According to a second aspect of the present invention, a random access method between a user equipment and a base station updates a route value used for the base station to generate a random access preamble at regular intervals.

The base station updates the route value in units of sub-frames for each frame and the sub-frame unit is set up by taking account of at least one of propagation delay, re-transmission, and latency delay.

The base station updates a route value by sequentially selecting a route value by using a codebook.

According to a third aspect of the present invention, a random access method between a user equipment and a base station comprises a period setup step in which the base station sets a period for detecting a random access preamble and a random access preamble detection step in which the base station detects the random access preamble received from the user equipment in the available period.

The random access preamble detection step comprises a boundary detection step in which the base station detects the boundary of the random access preamble in the period and a parameter extraction step in which a parameter is extracted from the random access preamble whose boundary has been detected.

In the boundary detection step, the base station detects the boundary of the random access preamble by using a cyclic shift or a repetition period of the random access preamble.

The base station detects the random access preamble by using a predetermined, single route value.

According to a fourth aspect of the present invention, a random access method between a user equipment and a base station comprises a system information receiving step in which the user equipment receives from the base station system information including a single route value updated at regular intervals and a random access preamble generation step in which the user equipment generates a random access preamble based on the system information.

In the system information receiving step, the user equipment receives from the base station the system information in units of sub-frames for each frame.

### Advantageous Effects

According to the present invention, since a base station updates a route value at regular intervals and transmits system information including a single route value to a user equipment and the user equipment generates a random access preamble by using the single route value, the base station does not necessarily have to calculate a cross correlation for each of route values included in a set of routes but can detect a random access preamble from a cross correlation value for a single route value, thereby reducing complexity for detection of a random access preamble at the time of carrying out a random access process.

Also, according to the present invention, since a base station is capable of setting up a period for detecting a random access preamble beforehand and detecting a random access preamble by using previously allocated resources in the period, complexity for detection of a random access preamble can be further reduced.

### DESCRIPTION OF DRAWINGS

FIG. 1 is a signal flow diagram illustrating a conventional random access process;

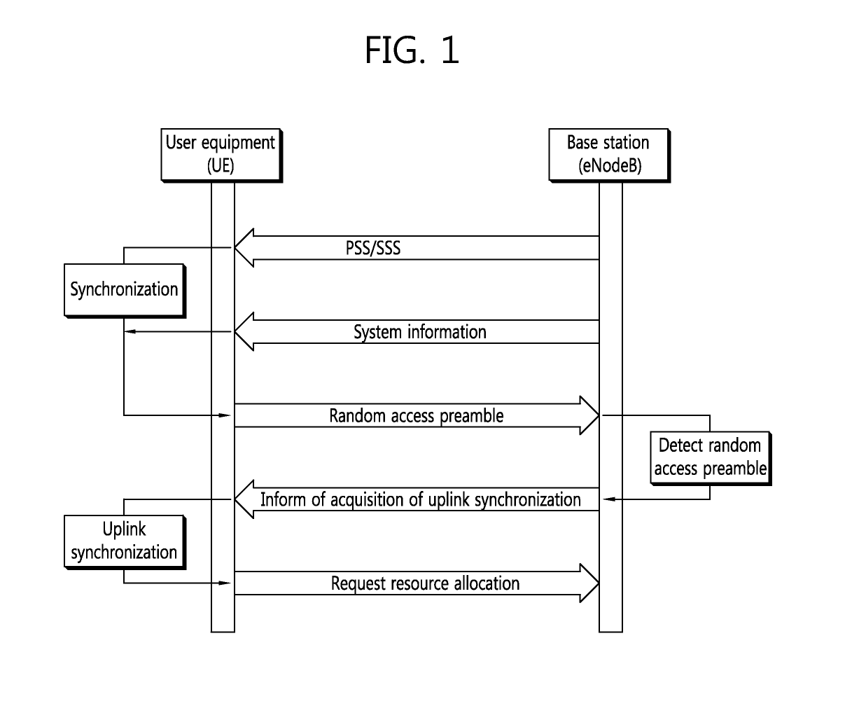

FIG. 2 illustrates a structure of a random access preamble;

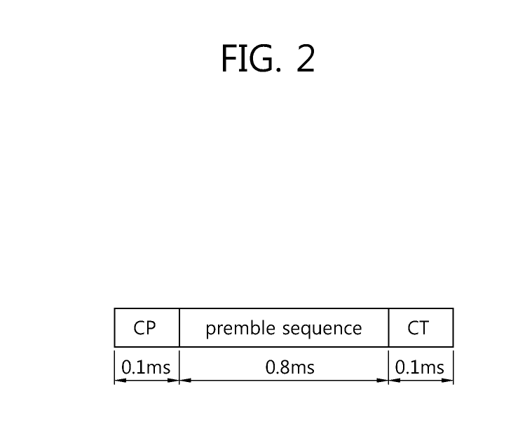

FIG. 3 is a flow diagram illustrating a random access process according to the present invention; and

FIG. 4 is a random access preamble detection process according to the present invention illustrated in the order of time.

### BEST MODE

### Mode for Invention

In what follows, embodiments of the present invention will be described in detail with reference to appended drawings. The structure of the present invention and consequent effects thereof will be clearly understood by detailed descriptions below.

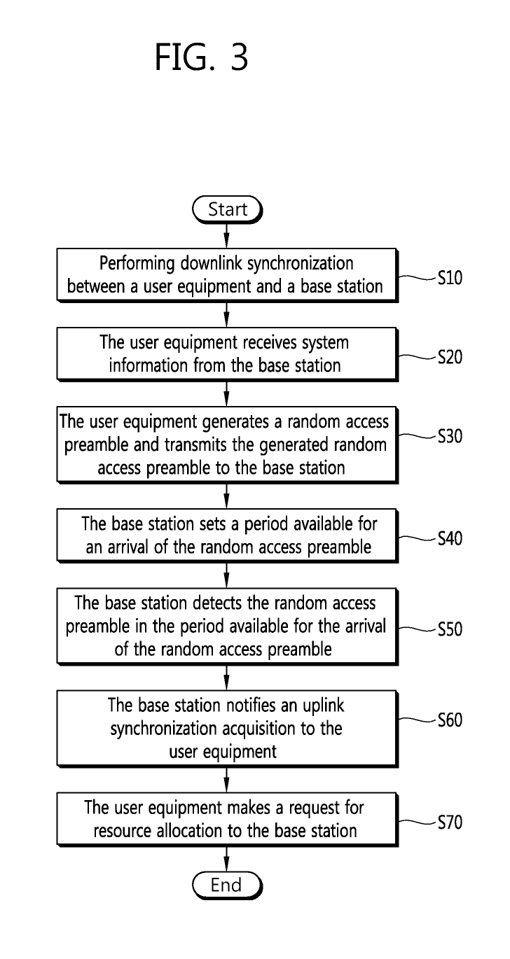

FIG. 3 is a flow diagram illustrating a random access process according to the present invention.

With reference to FIG. 3, a user equipment receives PSS and SSS from a base station and carries out downlink synchronization with the base station S10. After synchronization between the user equipment and the base station is established, the user equipment receives from the base station system information through a broadcasting channel S20. The system information includes a factor intended for generating a random access preamble. The system information according to the present invention includes a route value selected sequentially by the base station from among a set of available routes. The system information is transmitted to the user equipment in units of sub-frames for each frame.

Next, the user equipment generates a random access preamble based on the system information received from the base station and transmits the generated random access preamble to the base station S30. The user equipment generates 64 candidate random access preambles by using a single route value included in the system information. The user equipment, to generate the 64 candidate random access preambles, may allocate the size of CS as 46. The user equipment selects one from among the 64 candidate random access preambles and transmits the selected one to the base station.

The base station sets up a period available for an arrival of a random access preamble S40. Since the base station is aware of information about its cell radius, propagation delay, re-transmission, latency delay, resource allocation period, and so on, it can set up a period available for an arrival of a random access preamble by using such information.

The base station detects a received random access preamble in the available period S50. The base station can detect a random access preamble by calculating a cross correlation by using only a route value predetermined in the system information transmitted to the user equipment.

The random access preamble detection process of the base station comprises detecting a boundary of a random access preamble through a cross correlation in a period available for an arrival of a random access preamble and extracting a parameter from the random access preamble.

The base station notifies of acquisition of uplink synchronization by transmitting a preamble ID, an access approval message, and timing advance (TA) to a user equipment having the extracted parameter.

The user equipment, once obtaining the uplink synchronization, requests allocation of resources for uplink transmission from the base station by adjusting the timing advance received from the base station S70.

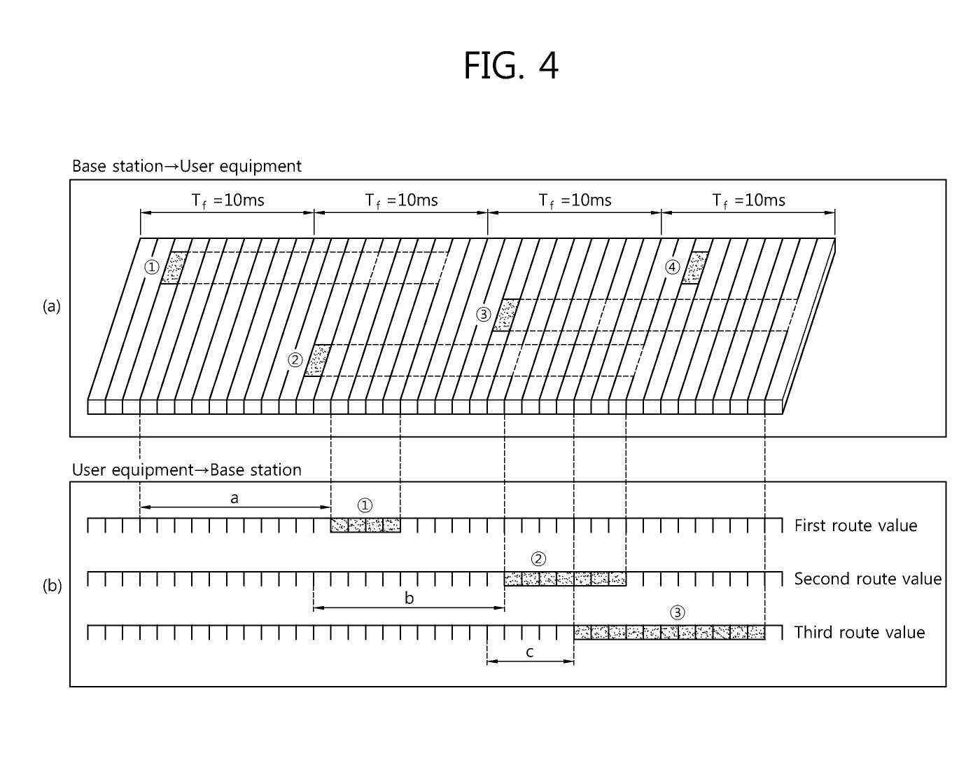

FIG. 4 is a random access preamble detection process according to the present invention illustrated in the order of time.

With reference to FIG. 4, (a) represents a time axis used for illustrating transmission of system information from a base station to a user equipment while (b) represents a time axis along which the base station receives a random access preamble from the user equipment.

Tf in FIG. 4(a) denotes a frame period. The frame period in this case is set to 10 ms. Each frame comprises a plurality of sub-frames. The symbols \textcircled{1}, \textcircled{2}, \textcircled{3}, and \textcircled{4} denote system information. Although the system information is contained in a single frame but can occupy one or more sub-frames. The sub-frame(s) occupied by the system information corresponds to a resource allocation period allocated by the base station.

The base station transmits system information to the user equipment in units of sub-frames for each frame. The sub-frame unit can be configured differently by taking account of information such as propagation delay, re-transmission, latency delay, and so on.

The system information has its own route value different from each other. The base station selects a route value selectively from among a set of available route values and inserts one route value to the system information. That is, the base station updates a route value used for generating a random access preamble at regular intervals and transmits the route value to the user equipment. The base station updates a route value in units of sub-frames for each frame in the same way as the transmission period of system information. The base station updates the route value by sequentially selecting the route value by using a codebook.

After the base station transmits the system information to the user equipment in units of sub-frames for each frame, the base station, by using information such as its cell radius, propagation delay, re-transmission, latency delay, and so on, sets up a period for detecting a random access preamble transmitted from the user equipment.

The symbols a, b, and c in FIG. 4(b) denote a delay time. The symbols \textcircled{1}, \textcircled{2}, and \textcircled{3} (appearing as shaded circles) correspond to a period available for an random access preamble and denote a period for detecting an random access preamble.

The base station, after transmitting system information \textcircled{1}, sets up a period for detecting a random access preamble after a predetermined delay time a as shown by \textcircled{1} (shaded circle). The base station detects a random access preamble by using a predetermined route value (a first route value) in the preamble detection period \textcircled{1} (shaded circle). More specifically, the base station detects a boundary of a random access preamble in the random access preamble detection period \textcircled{1} (shaded circle) and extracts a parameter from the random access preamble whose boundary has been detected.

The boundary of a random access preamble can be detected by using a cyclic shift or a repetition period of the random access preamble. In general, since a wireless communication system supporting a large cell radius comprises LOS (Line-Of-Sight) channels, the process of detecting a boundary of a random access preamble by calculating a cross correlation from a cyclic shift or repetition period can be considered a reasonable approach.

Similarly, the base station transmits system information \textcircled{2} and after a predetermined period of time b, sets up a random access preamble detection period as indicated by \textcircled{2} (shaded circle). The base station detects a random access preamble by using one route value (a second route value) predetermined in the preamble detection period \textcircled{2} (shaded circle). Also, the base station transmits system information \textcircled{3} and after a predetermined period of time c, sets up a random access preamble period as indicated by \textcircled{3} (shaded circle). The base station detects a random access preamble by using one route value (a third route value) predetermined in the preamble detection period \textcircled{3} (shaded circle).

At this time, it can be noticed that lengths of random access preamble detection periods differ from each other. This is because a random access preamble detection period is set up according to cell radius, propagation delay, re-transmission, latency delay, resource allocation period, and so on.

The process of calculating a cross correlation can be carried out in the time domain or frequency domain depending upon whether a route value is time information or frequency information. According to the present invention, since the base station detects a random access preamble by using only a single route value in a random access preamble detection period based on system information and delay time, detection complexity can be greatly reduced compared with conventional methods which calculate a cross correlation for each of route values belonging to a set of route values for the whole periods.

For example, considering interference in a network having a cell radius of about 100 km, the size of CS should be 419 or more. In case the size of CS is 419, the number of candidate random access preambles which can be generated through a single route value is 2. Therefore, a total of 32 route values are required to generate 64 candidate random access preambles.

Therefore, according to the conventional methods, since the base station has to detect a random access preamble by calculating a cross correlation for all the 32 route values across the whole sample periods, detection complexity can grow significantly. However, since the present invention provides a method for detecting a random access preamble by calculating a cross correlation for only one predetermined route value in a predetermined detection period independently of a cell radius, detection complexity can be greatly reduced.

The embodiments described in this document are not intended to limit the technical scope of the present invention. The technical scope of the present invention should be defined by appended claims and all the technologies belonging to a scope equivalent thereto should be understood to belong to the technical scope of the present invention.

1. A random access method between a user equipment and a base station, comprising:
a system information transmission step in which the base station transmits, to the user equipment, system information including route values sequentially selected from among a set of routes;
a random access preamble transmission step in which the user equipment generates a random access preamble on the basis of the system information and transmits the generated random access preamble to the base station;
a period setup step in which the base station sets a period available for an arrival of the random access preamble; and
a random access preamble detection step in which the base station detects the random access preamble in said available period.

2. The method of claim 1, wherein the base station transmits the system information in units of sub-frames for each frame in the system information transmission step.

3. The method of claim 1, wherein the base station sets up the available period by taking account of at least one of cell radius, propagation delay, re-transmission, latency delay, and resource allocation period in the period setup step.

4. The method of claim 1, wherein the base station detects the boundary of the random access preamble in the available period and extracts a parameter from the random access preamble in the random access preamble detection step.

5. A random access method between a user equipment and a base station comprising:
updating a route value used for the base station to generate a random access preamble at regular intervals.

6. The method of claim 5, wherein the base station updates the route value in units of sub-frames for each frame.

7. The method of claim 6, wherein the sub-frame unit is set up by taking account of at least one of propagation delay, re-transmission, and latency delay.

8. The method of claim 5, further comprising transmitting to the user equipment system information including a updated route value, where the updated route value is incorporated into system information by the base station.

9. The method of claim 8, wherein the base station transmits the system information to the user equipment through a broadcasting channel.

10. The method of claim 8, wherein the base station updates a route value by sequentially selecting a route value by using a codebook.

11. A random access method between a user equipment and a base station, comprising:
a period setup step in which the base station sets a period for detecting a random access preamble; and
a random access preamble detection step in which the base station detects the random access preamble received from the user equipment in the available period.

12. The method of claim 11, wherein the base station sets up the available period by taking account of at least one of cell radius, propagation delay, re-transmission, latency delay, and resource allocation period in the period setup step.

13. The method of claim 11, wherein the random access preamble detection step comprises a boundary detection step in which the base station detects the boundary of the random access preamble in the period; and
a parameter extraction step in which a parameter is extracted from the random access preamble whose boundary has been detected.

14. The method of claim 13, wherein the base station detects the boundary of the random access preamble by using a cyclic shift or a repetition period of the random access preamble in the boundary detection step.

15. The method of claim 11, wherein the base station detects the random access preamble by using a predetermined, single route value.

16. The method of claim 13, further comprising the base station's informing a user equipment having the extracted parameter about acquisition of uplink synchronization.

17. A random access method between a user equipment and a base station, comprising:
a system information receiving step in which the user equipment receives from the base station system information including a single route value updated at regular intervals; and
a random access preamble generation step in which the user equipment generates a random access preamble based on the system information.

18. The method of claim 17, wherein the user equipment receives from the base station the system information in units of sub-frames for each frame in the system information receiving step.

19. The method of claim 17, wherein the user equipment generates a plurality of candidate random access preambles by using the single route value in the random access preamble generation step.

20. The method of claim 19, further comprising the user equipment's transmitting to the base station one random access preamble from among the plurality of candidate random access preambles.

21. The method of claim 17, wherein the user equipment receives the system information from the base station through a broadcasting channel in the system information receiving step.
